(19) United States
(12) Patent Application Publication
(10) Pub. No.: US 2026/0303731 A1
(43) Pub. Date: Oct. 1, 2026

(54) IMAGE PROCESSING APPARATUS, CONTROL METHOD, AND STORAGE MEDIUM

(71) Applicant: CANON KABUSHIKI KAISHA, Tokyo (JP)

(72) Inventor: MIHO WATANABE, Tokyo (JP)

(21) Appl. No.: 19/558,676

(22) Filed: Mar. 6, 2026

(30) Foreign Application Priority Data
Mar. 31, 2025 (JP) 2025-058807

(51) Int. Cl. H04N 1/00; H04N 1/62

(52) U.S. Cl. CPC H04N 1/0044; H04N 1/62

(57) ABSTRACT

The usability is improved. An image processing apparatus includes: a display control unit configured to perform control to display a preview screen including an operation object to accept execution of processing of batch editing of an editing target and a preview image; and an execution unit configured to execute processing of batch editing of a target image, which is a source image including the set editing target in multiple source images each corresponding to a source of the preview image in a case where an operation performed on the operation object is accepted. In a case where the processing by the execution unit is executed, the display control unit changes display of the preview image corresponding to the target image to a state reflecting a processing result by the execution unit.

### BACKGROUND

### Field of the Technology

The present disclosure relates to preview display.

### Description of the Related Art

Some of image processing apparatuses have a function of performing rotation of a page and deletion of a page of a document obtained by scanning on a preview screen. In this case, a user can select the page on the preview screen and can rotate the selected page by pressing a rotation button. Additionally, the user can also select multiple pages and can rotate the selected multiple pages simultaneously. It is also possible to perform deletion of the page by a similar method.

Japanese Patent Laid-Open No. 2024-70918 discloses an image processing apparatus configured to display a preview screen. On the preview screen, a page selected by a user from multiple pages obtained by scanning is displayed as an editing target, and additionally, alternative images corresponding to pages preceding and following the selected page are displayed.

### SUMMARY

It is bothersome for the user who frequently performs similar operations on the preview screen to search for or select the corresponding page every time. For this reason, there has been a demand for achieving good usability.

An image processing apparatus comprising: one or more processors; and one or more memories storing instructions that, when executed by the one or more processors, cause the image processing apparatus to:

Features of the present disclosure will become apparent from the following description of embodiments with reference to the attached drawings. The following description of embodiments are described by way of example.

### BRIEF DESCRIPTION OF THE DRAWINGS

FIG. 1 is a block diagram illustrating a hardware configuration of an image processing apparatus;

FIG. 2 is a diagram illustrating an example of a software configuration that is a function of the image processing apparatus;

FIG. 3 is a flowchart illustrating an example of presetting processing;

FIG. 4A is a diagram showing an example in which each item is in a non-selected state;

FIG. 4B is a diagram showing an example in which a part of the items is in the selected state;

FIG. 5A is a diagram illustrating a first screen to designate the black-coloring target;

FIG. 5B is a diagram illustrating a second screen displayed after the first screen;

FIG. 5C is a diagram illustrating the second screen on which the black-coloring target is designated;

FIG. 6 is a flowchart illustrating an example of batch editing processing in a first embodiment;

FIG. 7A is an example of the preview screen before the batch editing;

FIG. 7B is the preview screen after the batch editing;

FIG. 8 is a flowchart illustrating an example of the batch editing processing in a second embodiment;

FIG. 9 is a diagram illustrating an example of a pop-up screen;

FIG. 10 is a flowchart illustrating an example of the batch editing processing in a third embodiment;

FIG. 11 is a diagram illustrating an example of a confirmation screen;

FIG. 12A is an example of the preview screen after the batch editing; and

FIG. 12B is the preview screen in a case of restoring to a state before the batch editing.

### DESCRIPTION OF THE EMBODIMENTS

Hereinafter, with reference to the attached drawings, the present disclosure is explained in detail in accordance with preferred embodiments. Configurations shown in the following embodiments are merely exemplary and the present disclosure is not limited to the configurations shown schematically. Incidentally, an identical reference numeral is assigned to an identical constituent and an explanation thereof is made.

### First Embodiment

In the present embodiment, an example in which preview editing is executed efficiently by performing presetting to perform preview editing of a document obtained by scanning with one button and executing preset editing processing with one button is described.

### Hardware Configuration of Image Processing Apparatus

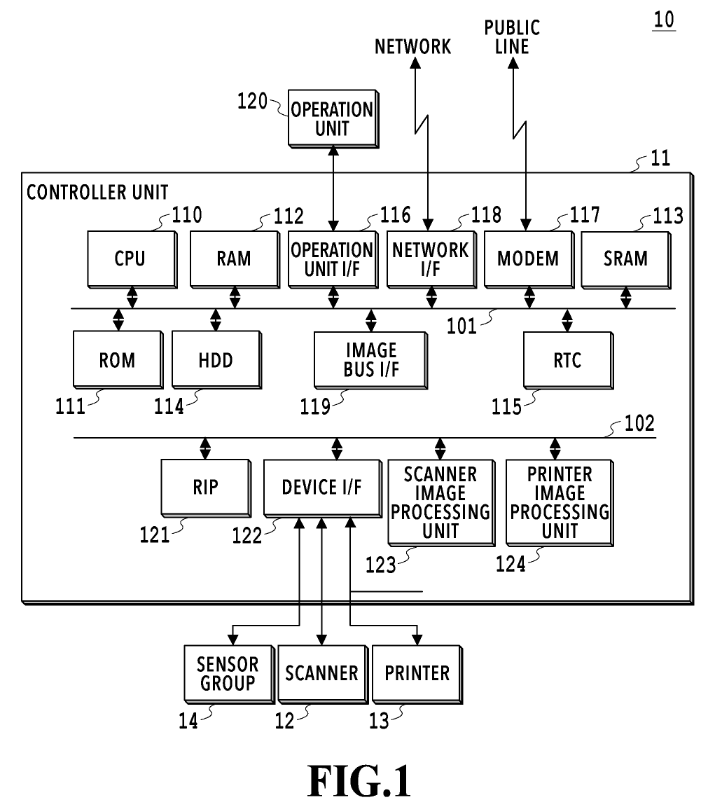

FIG. 1 is a block diagram illustrating a hardware configuration of an image processing apparatus 10. The image processing apparatus 10 includes a controller unit 11, a scanner 12, a printer 13, and a sensor group 14. The controller unit 11 performs control of the image processing apparatus 10. The scanner 12 is a reading apparatus and is also an image input device. The scanner 12 reads the document as an image and inputs data of the read image to the controller unit 11. The printer 13 is a printing apparatus and is also an image output device. The printer 13 prints data of the image and the like on a printing medium such as paper. The sensor group 14 includes various sensors.

In the present embodiment, the scanner 12 and the printer 13 are provided to the image processing apparatus 10; however, the scanner 12 and the printer 13 may be provided outside the image processing apparatus 10. In this case, the image processing apparatus 10 performs input and output of various types of information between the scanner 12 and the printer 13 via a network.

The controller unit 11 includes a system bus 101 and an image bus 102. The system bus 101 is a main path for communication of data between components. The image bus 102 is a dedicated path to transfer the image data at high speed. For example, the image bus 102 includes a PCI bus or IEEE 1394.

A CPU 110, a ROM 111, a RAM 112, an SRAM 113, an HDD 114, an RTC 115, an operation unit I/F 116, a modem 117, a network I/F 118, and an image bus I/F 119 are connected to the system bus 101.

The CPU 110 performs control to implement various functions of the image processing apparatus 10. The CPU 110 includes one or more processors. The CPU 110 performs various types of processing by executing a program or activating hardware. The execution of the program is performed by loading the program into the RAM 112. The processing performed by the CPU 110 may be performed in cooperation with a not-illustrated GPU.

The ROM 111 stores various data. For example, the ROM 111 stores the program. The program includes a boot program, a device driver that allows a device to operate, or the like. The RAM 112 is used as a working memory of the CPU 110. That is, the RAM 112 stores data required to execute the processing performed by the CPU 110.

The SRAM 113 is a non-volatile storage medium that may operates at high speed. The HDD 114 is a high-capacity storage medium. The SRAM 113 or the HDD 114 stores various data such as system software, an application, and the image data.

The RTC 115 is a real-time clock. The RTC 115 performs processing of counting clock time also in a state in which the controller unit 11 is powered off. The operation unit I/F 116 provides and receives the data between the controller unit 11 and an operation unit 120. The operation unit 120 may display various user interfaces in a display region and may also accept input of an instruction and the like according to an operation by the user performed on the operation unit 120. The operation unit 120 may be a touch panel including a liquid crystal layer and a touch sensor layer.

The modem 117 is connected to a public line and performs input and output of information via the connected public line. The network I/F 118 is connected to the network and performs input and output of information via the connected network. The image bus I/F 119 is a bus bridge that connects the system bus 101 and the image bus 102 and converts a data structure.

An RIP 121, a device I/F 122, a scanner image processing unit 123, and a printer image processing unit 124 are connected to the image bus 102.

The RIP 121 is a raster image processor. The RIP 121 rasterizes a PDL code into a bitmap image. The device I/F 122 provides and receives data between the controller unit 11 and various devices. The various devices include the scanner 12, the printer 13, and the sensor group 14. The device I/F 122 performs conversion of the image data between a synchronous system and an asynchronous system. The scanner image processing unit 123 performs various types of image processing such as correction, processing, and editing on the image data inputted from the scanner 12 to the controller unit 11. The printer image processing unit 124 performs various types of image processing such as correction and resolution conversion of the printer on the image data as a target outputted from the controller unit 11 to the printer 13.

### Software Configuration of Image Apparatus

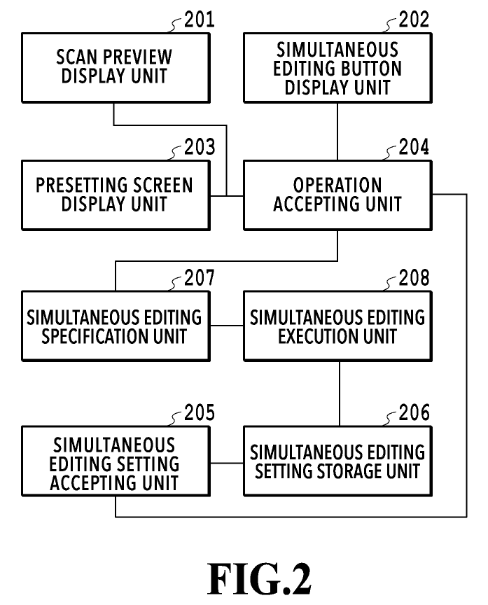

FIG. 2 is a diagram illustrating an example of a software configuration that is a function of the image processing apparatus 10. In the image processing apparatus 10, each functional unit functions with the CPU 110 loading the program installed in the HDD 114 and the like into the RAM 112 and executing the loaded program. The functional units include a scan preview display unit 201, a batch editing button display unit 202, a presetting screen display unit 203, an operation accepting unit 204, a batch editing setting accepting unit 205, a batch editing setting storage unit 206, a batch editing specification unit 207, and a batch editing execution unit 208.

The scan preview display unit 201 performs processing of displaying a preview screen of the document read by the scanner 12. The batch editing button display unit 202 displays a button to accept execution of processing of batch editing of an editing target. The button is one of operation objects that can be operated in the display region. An operation object other than the button may be displayed. The presetting screen display unit 203 displays a presetting screen that is a screen to perform presetting related to the processing of batch editing of the editing target. The operation accepting unit 204 accepts input of the instruction and the like corresponding to the operation by the user. The batch editing setting accepting unit 205 accepts setting related to the processing of batch editing of the editing target. The batch editing setting storage unit 206 stores setting information that is information indicating contents of the setting related to the processing of batch editing of the editing target. Based on the setting information, the batch editing specification unit 207 specifies a target page (target image), which is a page (source image) including the set editing target, from multiple pages (multiple source images) read by the scanner 12. Based on the setting information, the batch editing execution unit 208 executes processing of batch editing of the target page.

### Presetting Processing

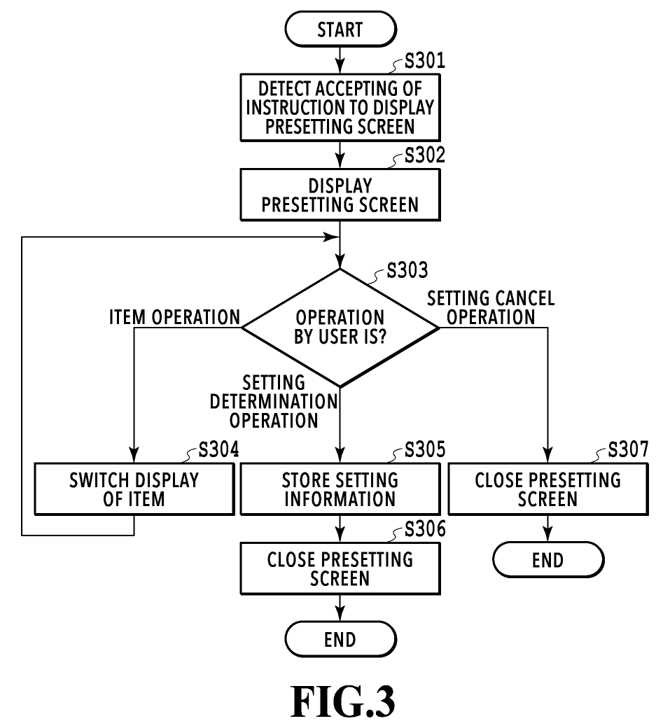

Next, presetting processing is described. The presetting processing is setting processing to execute the preview editing with one button. FIG. 3 is a flowchart illustrating an example of the presetting processing. A series of processing illustrated in the flowchart in FIG. 3 is the presetting processing. The presetting processing is started once the image processing apparatus 10 is powered on, for example. Each step illustrated in the flowchart in FIG. 3 is processed with the CPU 110 of the image processing apparatus 10 executing the program stored in the ROM 111 and the like. That is, the processing in each step is executed by one of the functional units illustrated in FIG. 2. Note that, a part of or all the processing in each step may be implemented by hardware such as an ASIC or an electronic circuit. Additionally, a sign "S" in the following descriptions of the flowcharts indicates a step.

In S301, the operation accepting unit 204 detects accepting of an instruction to display the presetting screen. For example, once the instruction to display the presetting screen is accepted according to the operation by the user performed on a presetting item in a not-illustrated setting menu, the processing proceeds to S302.

In S302, the presetting screen display unit 203 displays the presetting screen in the display region of the operation unit 120. Thereafter, the processing proceeds to S303. In S303, the presetting screen display unit 203 judges the operation by the user performed on the presetting screen. The operation includes an item operation, a setting determination operation, and a setting cancel operation.

The item operation is a selection operation or a selection releasing operation performed on an item displayed on the presetting screen. If it is judged that the operation by the user is the selection operation or the selection releasing operation, the presetting screen display unit 203 allows the processing to proceed to S304. In S304, the presetting screen display unit 203 switches the display of the item. For example, the presetting screen display unit 203 switches the item on which the selection operation is performed to the display of a selected state. Alternatively, the presetting screen display unit 203 switches the item on which the selection releasing operation is performed to the display of a non-selected state. Once the display of the item is switched, the processing returns to S303.

The setting determination operation is an operation to determine setting of batch editing. If it is judged that the operation by the user is the setting determination operation, the presetting screen display unit 203 allows the processing to proceed to S305. In S305, the batch editing setting storage unit 206 generates the setting information and stores the setting information into the HDD 114 or the like. The setting information includes information related to the item switched to the display of the selected state. Note that, in a case where the setting information generated previously is stored in the HDD 114 or the like, the batch editing setting storage unit 206 may discard the setting information generated previously. Once the setting information is stored, the processing proceeds to S306. In S306, the presetting screen display unit 203 closes the presetting screen. Thereafter, the presetting processing ends.

The setting cancel operation is an operation to cancel the setting of the batch editing. If it is judged that the operation by the user is the setting cancel operation, the presetting screen display unit 203 allows the processing to proceed to S307. In S307, the presetting screen display unit 203 closes the presetting screen. Thereafter, the presetting processing ends.

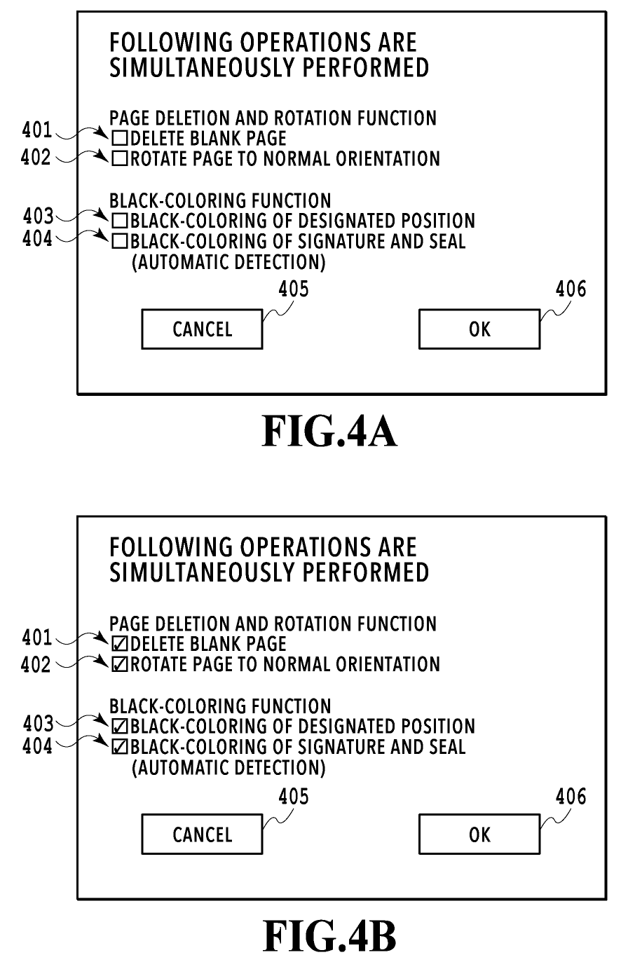

FIG. 4 is a diagram illustrating an example of the presetting screen. Specifically, FIG. 4A illustrates an example of a case where each item is in the non-selected state, FIG. 4B illustrates an example of a case where a part of the items is in the selected state.

The item is an item to set editing contents that are contents of the processing of batch editing of the editing target. The editing contents of the items are different from each other. In the example in FIG. 4, as the items, a blank deletion item 401, a reverse rotation item 402, a first black-coloring item 403, and a second black-coloring item 404 are displayed on the presetting screen. Additionally, in the example in FIG. 4, a cancel button 405 to perform the setting cancel operation and an OK button 406 to perform the setting determination operation are displayed on the presetting screen. Moreover, in the example in FIG. 4, a checkbox corresponding to each item is displayed. In a case where the user performs the selection operation on the item, a check mark is displayed in the checkbox. In a case where the user performs the selection releasing operation on the item, the check mark displayed in the checkbox is hidden.

The blank deletion item 401 is an item to simultaneously delete a blank page that is a page including no printing portion as the editing target, in the multiple pages read by the scanner 12. The blank page is detected by the scanner image processing unit 123. Information indicating the detected blank page is supplied to the CPU 110. The CPU 110 stores and sets the information indicating the blank page into the HDD 114 or the like. Based on the information indicating the blank page, each functional unit illustrated in FIG. 2 may judge whether there is a page including the blank page in the multiple pages read by the scanner 12. As a method of detecting the blank page, for example, there is a method in which a brightness value of each pixel in the page is compared with a threshold, and the blank page is detected based on a ratio of the pixels equal to or greater than the threshold. Alternatively, there is a method of detecting the blank page by detecting a reflectivity with an optical sensor.

The reverse rotation item 402 is an item to simultaneously rotate a reverse page that is a page in a reversed orientation to a normal state, as the editing target, in the multiple pages read by the scanner 12. The reverse page is detected by the scanner image processing unit 123. For example, the scanner image processing unit 123 executes character recognition processing (OCR: Optical Character Recognition) and detects the reverse page based on an orientation of a character. Information indicating the detected reverse page is supplied to the CPU 110. The CPU 110 stores and sets the information indicating the reverse page into the HDD 114 or the like. Based on the information indicating the reverse page, each functional unit illustrated in FIG. 2 may judge whether there is a page including the reverse page in the multiple pages read by the scanner 12.

The first black-coloring item 403 is an item to simultaneously perform black-coloring on a document portion designated by the user, as the editing target, in the multiple pages read by the scanner 12. The black-coloring is processing of replacing a pixel value of a black-coloring target with a value corresponding to a black color.

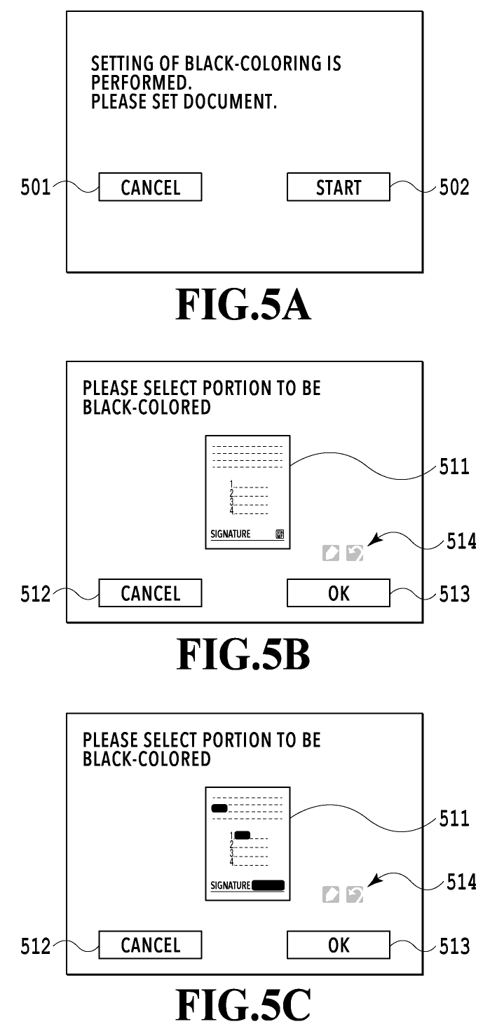

FIG. 5 is a diagram describing designation of the black-coloring target. Specifically, FIG. 5A is a diagram illustrating a first screen to designate the black-coloring target, and FIG. 5B is a diagram illustrating a second screen displayed after the first screen. Additionally, FIG. 5C is a diagram illustrating the second screen on which the black-coloring target is designated.

For example, in a case where the selection operation is performed on the first black-coloring item 403 illustrated in FIG. 4A, and thereafter the setting determination operation is performed on the OK button 406, the CPU 110 displays the first screen in the display region of the operation unit 120. On the first screen, a message prompting the user to set the document that is to be black-colored to the scanner 12 is displayed. Additionally, on the first screen, a cancel button 501 and a start button 502 are displayed. Once the user performs an operation of pressing the start button 502, the CPU 110 requests the scanner 12 to read the document.

Once the reading of the document is completed, the CPU 110 displays the second screen in the display region of the operation unit 120 instead of the first screen. On the second screen, a preview image 511 of the document read by the scanner 12 and a message prompting the user to designate a black-coloring portion are displayed. Additionally, on the second screen, a cancel button 512, an OK button 513, and an icon 514 to designate the black-coloring portion are displayed. After the user performs an operation of pressing the icon 514, the user designates the black-coloring portion in the preview image 511.

Once the designation of the black-coloring portion is accepted, as illustrated in FIG. 5C, the CPU 110 performs black-coloring of the black-coloring portion on the preview image 511. Once the user performs an operation of pressing the cancel button 512, the CPU 110 discards the designation of the black-coloring portion and closes the second screen. On the other hand, once the user performs an operation of pressing the OK button 513, the CPU 110 stores and sets information indicating a format of the document and a position (position of the black-coloring portion) designated in the document into the HDD 114 or the like and closes the second screen. The format of the document is, for example, the number of lines in the page, a frame border, a character string obtained by the character recognition processing (OCR), and so on. Based on the information indicating the format of the document and the position designated in the document, each functional unit illustrated in FIG. 2 may judge whether there is a page including the document portion designated by the user in the multiple pages read by the scanner 12.

The second black-coloring item 404 is an item to perform black-coloring of signature and seal, as the editing target, in the multiple pages read by the scanner 12. The signature and seal is at least one of a signature and a seal. As an automatic detection method of the signature and seal, for example, there is a detection method by AI-OCR using an AI technique called deep learning. In a case of using the detection method, the scanner image processing unit 123 automatically detects the signature and seal in the multiple pages by using an AI-OCR model that is a learned machine learning model. Information indicating an automatic detection result is supplied to the CPU 110. The CPU 110 stores and sets the information indicating the automatic detection result into the HDD 114 or the like. Based on the information indicating the automatic detection result, each functional unit illustrated in FIG. 2 may judge whether there is a page including the signature and seal in the multiple pages read by the scanner 12. Note that, although the automatic detection target is the signature and seal in the present embodiment, it is not limited thereto. For example, personal information such as an address, a date of birth, a telephone number, an e-mail address, and a face photograph may be adopted as the automatic detection target.

Note that, in a case where a result of the black-coloring using the learned AI-OCR model is different from the expectation by the user, the CPU 110 may create training data based on the page of the document and may store the training data into the HDD 114 or the like. The training data includes information indicating a correct coordinate (region) of the signature and seal, information indicating the signature and seal, information indicating the color of the signature and seal, information indicating whether there is underline, and the like. Additionally, the CPU 110 may perform relearning of the AI-OCR model in the scanner image processing unit 123 by using the training data stored in the HDD 114 or the like.

### Batch editing Processing

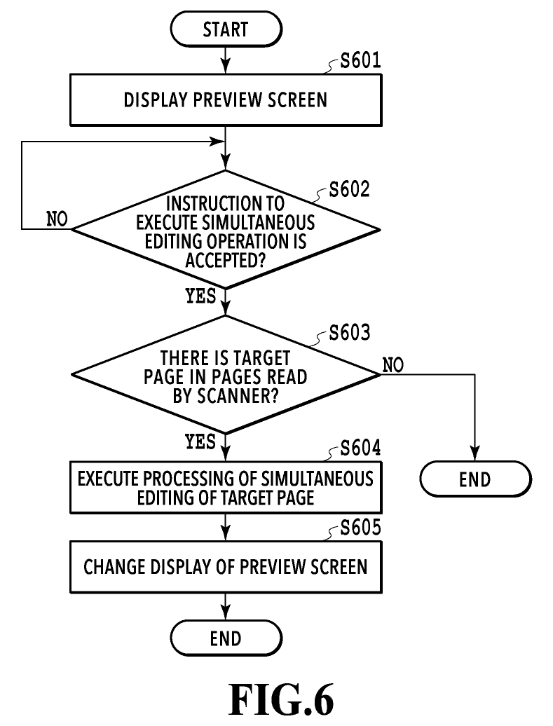

Next, batch editing processing is described. The batch editing processing is a process of collectively executing the preview editing via a single button operation. FIG. 6 is a flowchart illustrating an example of the batch editing processing in a first embodiment. A series of processing illustrated in the flowchart illustrated in FIG. 6 is the batch editing processing. The batch editing processing is started once an instruction of scan job is accepted. Each step illustrated in the flowchart in FIG. 6 is processed with the CPU 110 of the image processing apparatus 10 executing the program stored in the ROM 111 and the like. That is, the processing in each step is executed by one of the functional units illustrated in FIG. 2. Note that, a part of or all the processing in each step may be implemented by hardware such as an ASIC or an electronic circuit.

In S601, the CPU 110 displays the preview screen of the document read by the scanner 12 in the display region of the operation unit 120. That is, the CPU 110 requests the scanner 12 to scan the document and obtains the multiple pages read by the scanner 12. The CPU 110 generates the preview screen based on the obtained multiple pages and displays the generated preview screen in the display region of the operation unit 120. The preview screen includes an operation object to accept the execution of the processing of batch editing of the editing target and the preview image. Note that, on the preview screen, the preview image corresponding to each page may be displayed in a thumbnail format, or the preview image greater than the thumbnail format may be displayed for each page. Once the preview screen is displayed, the CPU 110 allows the processing to proceed to S602.

In S602, the CPU 110 stands by for an operation by the user performed on the operation object. According to the operation by the user performed on the operation object displayed on the preview screen, the CPU 110 accepts an instruction to execute the processing of batch editing of the editing target. In this case, the CPU 110 allows the processing to proceed to S603.

In S603, the CPU 110 judges whether there is the target page, which is the page including the editing target, in the multiple pages read by the scanner 12. The judgement is performed based on the setting information stored by the setting determination operation on the presetting screen in S305. For example, as illustrated in FIG. 4B, in a case where the OK button 406 is pressed in a state in which the blank deletion item 401, the reverse rotation item 402, and the second black-coloring item 404 are selected, whether there are the blank page, the reverse page, and the page including the signature and seal as the target page is judged. Alternatively, although it is not illustrated, in a case where the OK button 406 is pressed in a state in which only the blank deletion item 401 is selected, whether there is the blank page as the target page is judged. In a case where there is no target page in the pages, the CPU 110 ends the batch editing processing. On the other hand, in a case where there is the target page in the pages, the CPU 110 allows the processing to proceed to S604.

In S604, the CPU 110 executes the processing of batch editing of the target page and allows the processing to proceed to S605. Then, the CPU 110 changes the display of the preview screen. Specifically, the CPU 110 changes the display of the preview image indicating the target page to a state reflecting a processing result of the editing processing. Thereafter, the CPU 110 ends the batch editing processing.

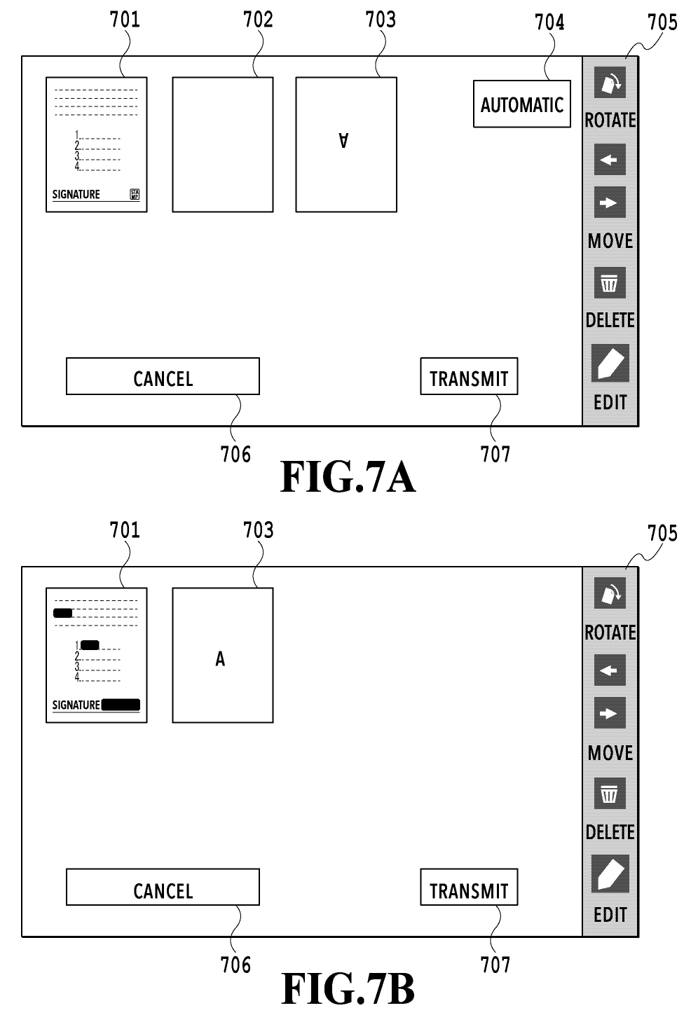

FIG. 7 is a diagram illustrating an example of the preview screen. Specifically, FIG. 7A is an example of the preview screen before the batch editing, and FIG. 7B is the preview screen after the batch editing. The preview screen before the batch editing illustrated in FIG. 7A is an example of the preview screen displayed in S601 illustrated in the flowchart in FIG. 6. The preview screen after the batch editing illustrated in FIG. 7B is an example of the preview screen displayed in S605 illustrated in the flowchart in FIG. 6.

In the example in FIG. 7A, the preview image corresponding to each of the multiple pages read by the scanner 12 is displayed on the preview screen in the thumbnail format. Specifically, a signature and seal image 701, a blank image 702, and a reverse image 703 are displayed. The signature and seal image 701 is the preview image corresponding to the page including the signature and seal. The blank image 702 is the preview image corresponding to the blank page. The reverse image 703 is the preview image corresponding to the reverse page.

Additionally, in the example in FIG. 7A, an automatic button 704 is displayed on the preview screen as the operation object to accept the execution of the processing of batch editing of the editing target. Moreover, in the example in FIG. 7A, an operation menu 705 to accept execution of procedure of manual editing is displayed on the preview screen. As the operation menu 705, a rotation button, a movement button, a deletion button, and an editing button are displayed.

The user operates the operation menu 705 in a case where the user desires manual editing of the page read by the scanner 12. For example, the user selects the preview image that the user desires to edit by pressing the movement button and performs an operation of pressing the rotation button, the deletion button, or the editing button. According to the operation, the CPU 110 edits the page corresponding to the selected preview image.

The user presses the automatic button 704 in a case where the user desires batch editing of the page read by the scanner 12. With the pressing, in the flowchart illustrated in FIG. 6, the processing proceeds from S602 to S603. In a case where the setting of the batch editing is performed as the presetting screen illustrated in FIG. 4B, in the example in FIG. 7A, the page corresponding to each of the signature and seal image 701, the blank image 702, and the reverse image 703 is the target page. Therefore, the display reflecting the processing of batch editing of the target page in S605 of the flowchart illustrated in FIG. 6 is in a state illustrated in FIG. 7B. Specifically, a portion corresponding to the signature and seal in the signature and seal image 701 is black-colored. Additionally, the blank image 702 is deleted from the preview screen. Moreover, the orientation of the reverse image 703 is rotated to the normal orientation.

Additionally, in the example in FIG. 7A, a cancel button 706 and a transmission button 707 are displayed. Once the user performs an operation of pressing the cancel button 706, the CPU 110 closes the preview screen. On the other hand, once the user performs an operation of pressing the transmission button 707, the CPU 110 closes the preview screen and transmits the multiple pages read by the scanner 12 to the printer 13. Note that, in a case where at least one of the manual editing and the batch editing is performed, the page transmitted to the printer 13 is the page after editing.

According to the present embodiment as described above, it is possible to achieve good usability. For example, the CPU 110 as a display control unit performs control to display the preview screen including the preview image and the automatic button 704. Additionally, in a case where the operation of pressing the automatic button 704 is performed, the CPU 110 as an execution unit executes the processing of batch editing of the target page including the editing target from the multiple pages each corresponding to the source of the preview image. In a case where the processing is executed, the CPU 110 changes the display of the preview image corresponding to the target page to a state reflecting the processing result of the editing.

That is, once one operation is performed on the automatic button 704, the page as the target of the batch editing is automatically edited, and the editing result is reflected to the preview screen. Accordingly, the user may determine whether to perform printing of the image of each page read by the scanner 12 after confirming whether the result of the batch editing is performed as expected by the user. As a result, it is possible to efficiently perform the operations until the transmission of the document.

Additionally, the CPU 110 changes the display of the preview image to a state reflecting the processing result of the editing and hides the automatic button 704 on the preview screen (see FIG. 7B). Thus, the number of times executing the processing of batch editing of the target page is never more than one. Therefore, the operation is simple for the user, and a load on the user is reduced. Additionally, restoration is easier than a case where the number of times executing the processing of batch editing of the target page is two or more.

Moreover, the CPU 110 as a setting unit performs the presetting processing to set at least one of the multiple items of different editing contents. The CPU 110 as the execution unit executes the processing of batch editing of the target page corresponding to the set editing contents. Thus, it is possible to simultaneously edit the pages corresponding to one or more items desired by the user, and this leads to improvement in the operability.

Note that, although the processing of editing the target page is the deletion of the blank page, the rotation of the reverse page, and the black-coloring of the document portion or the signature and seal in the present embodiment, it is not limited thereto.

### Second Embodiment

In the first embodiment, an example in which the batch editing processing ends in a case where there is no target page in the multiple pages read by the scanner 12. In the present embodiment, an example in which, in a case where there is no target page, the user is notified that no editing processing is executed before the batch editing processing ends is described. Note that, hereinafter, descriptions of contents common to the first embodiment are omitted as needed, and different points are mainly described.

### Batch editing Processing

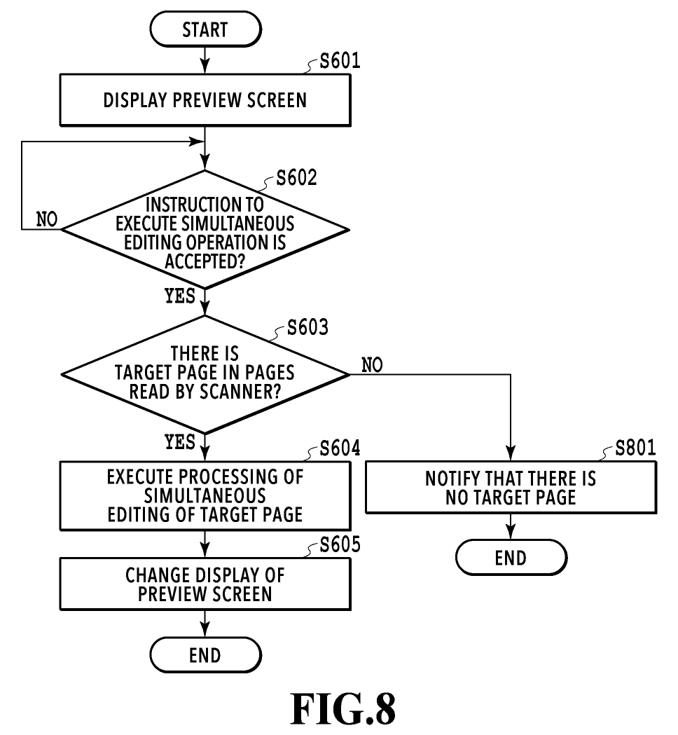

FIG. 8 is a flowchart illustrating an example of the batch editing processing in the second embodiment. In the flowchart illustrated in FIG. 8, processing in S801 is added to the flowchart illustrated in FIG. 6. If there is no target page in the multiple pages read by the scanner 12 in S603, The CPU 110 allows the processing to proceed to S801.

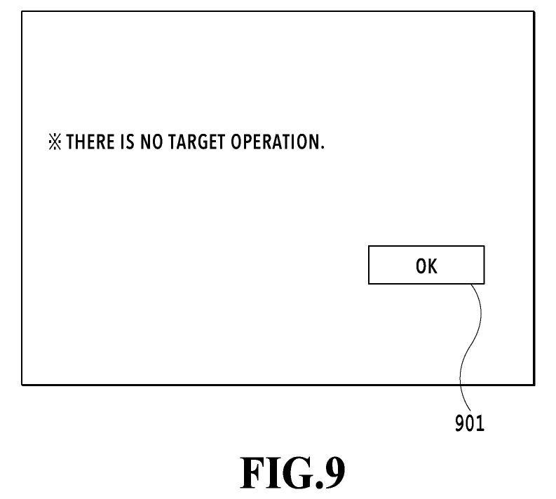

In S801, the CPU 110 notifies that there is no target page. For example, the CPU 110 displays a pop-up screen in the display region of the operation unit 120 and notifies that there is no target page. FIG. 9 is a diagram illustrating an example of the pop-up screen. In the example in FIG. 9, a message indicating that there is no target page (target operation) and an OK button 901 are displayed on the pop-up screen. Once the user performs an operation of pressing the OK button 901, the CPU 110 closes the pop-up screen and ends the batch editing processing.

As described above, in the present embodiment, in a case where there is no target page, The CPU 110 notifies that there is no target page. Thus, it is possible to notify the user that no effect of the batch editing is obtained because there is no target page. As a result, it is possible to provide the user with an opportunity to reconfirm the presetting related to the batch editing or reconfirm the document read by the scanner 12.

Note that, although the notification is the display in the display region in the present embodiment, the notification may be sound transmission, lighting or blinking of a warning light, or vibration of a vibration unit. Alternatively, as the notification, at least two of the display in the display region, the transmission of sound, the lighting or blinking of the warning light, and the vibration of the vibration unit may be combined with each other.

### Third Embodiment

In the first embodiment, an example in which the batch editing result is immediately reflected to the display of the preview screen is described. In the present embodiment, an example in which the batch editing result is reflected to the display of the preview screen after the user is allowed to confirm the batch editing result. Note that, hereinafter, descriptions of contents common to the first embodiment are omitted as needed, and different points are mainly described.

### Batch editing Processing

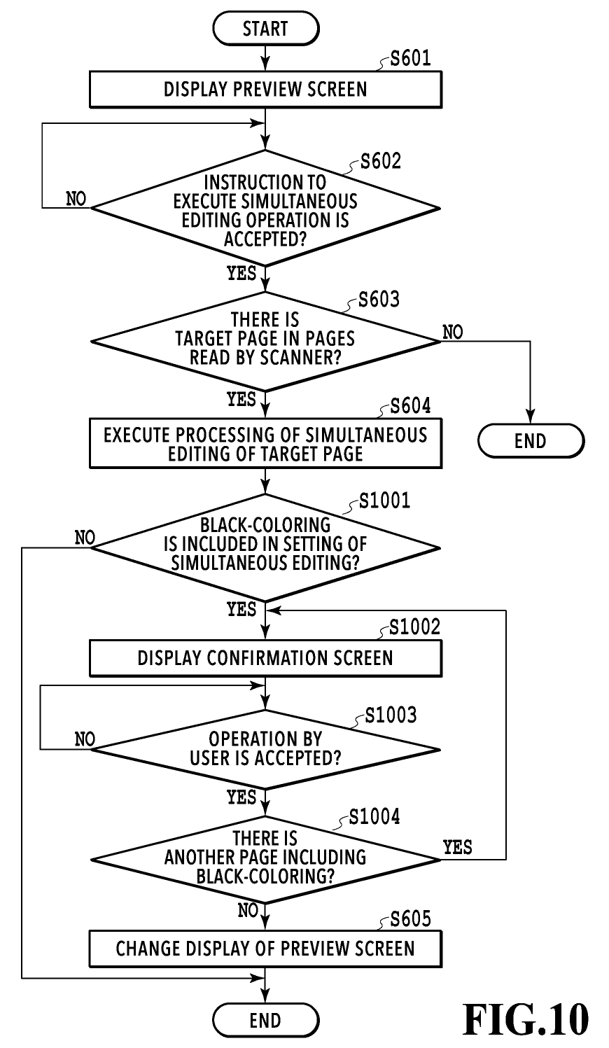

FIG. 10 is a flowchart illustrating an example of the batch editing processing in the third embodiment. In the flowchart illustrated in FIG. 10, each processing of S1001 to S1004 is added between the processing in S604 and the processing in S605 in the flowchart illustrated in FIG. 6.

In S1001, the CPU 110 judges whether the black-coloring is included in the setting of the processing of batch editing of the editing target. The judgement is performed based on the setting information stored by the setting determination operation on the presetting screen in S305. If it is judged that the black-coloring is not included in the setting of the processing of batch editing of the editing target, the CPU 110 allows the processing to proceed to S605. On the other hand, if it is judged that the black-coloring is included in the setting of the processing of batch editing of the editing target, the CPU 110 allows the processing to proceed to S1002.

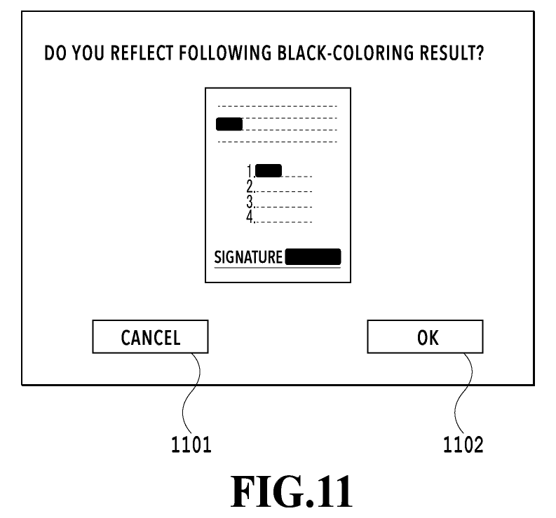

In S1002, the CPU 110 displays the confirmation screen indicating the page including the black-coloring in the display region of the operation unit 120. FIG. 11 is a diagram illustrating an example of the confirmation screen. In the example in FIG. 11, the page including the black-coloring and a message asking whether to apply the black-coloring are displayed on the confirmation screen. Additionally, a cancel button 1101 to cancel the black-coloring in the displayed page including the black-coloring and an OK button 1102 to allow the black-coloring in the displayed page including the black-coloring are displayed on the confirmation screen. Once the confirmation screen is displayed, the processing proceeds to S1003.

In S1003, the CPU 110 stands by for an operation by the user performed on the cancel button 1101 or the OK button 1102. Once the operation of pressing the cancel button 1101 or the OK button 1102 is accepted, the CPU 110 allows the processing to proceed to S1004. Note that, in a case where the operation of pressing the cancel button 1101 is accepted, the CPU 110 may display a message prompting an editing operation like "you can edit with the operation menu on the preview screen."

In S1004, the CPU 110 judges whether there is the page including the black-coloring in the pages of the document read by the scanner 12, in addition to the page including the black-coloring displayed on the confirmation screen in S1002. If there is the other page including the black-coloring, the CPU 110 returns to S1002, and if there is no other page including the black-coloring, the CPU 110 allows the processing to proceed to S605.

In S605, the CPU 110 switches the display of the preview screen to the display reflecting the result of the processing of batch editing of the target page. In the present embodiment, in a case where the processing of batch editing of the target page is the black-coloring, a result of the black-coloring performed on the target page that is allowed by the user is reflected, but a result of the black-coloring performed on the target page that is canceled by the user is not reflected.

As described above in the present embodiment, the CPU 110 as a result display control unit performs control to display the image of the target page on which the processing of batch editing of the editing target is executed. In a case where there are multiple images of the target pages, the CPU 110 performs control to individually display the multiple images of the target pages. Thus, it is possible to cancel the editing processing in a case where the editing result is different from the expectation of the user, and this leads to improvement in the operability.

Additionally, in a case where the user allows the processing result of the editing, the CPU 110 changes the display of the preview image according to the allowed processing result. Thus, this leads to improvement in a satisfaction degree of the user.

In the present embodiment, the image of the target page displayed in units of pages is the image including the black-coloring; however, the image of the target page displayed in units of pages may be the image of the blank page, the image of the reverse page, or the image of the page on which other editing processing is executed.

### About Present Disclosure

The present disclosure is not limited to the above-described embodiment.

For example, although the CPU 110 hides the automatic button 704 on the preview screen while changing the display of the preview image to the state reflecting the processing result of the editing in the above-described embodiment, the automatic button 704 may remain on the preview screen. Alternatively, the CPU 110 may change the display of the automatic button 704 to an operation disabled state while changing the display of the preview image to the state reflecting the processing result of the editing. For example, the operation disabled state includes a grayed out state, a state with a high transparency, or the like. Even with this, a similar effect as that of the above-described embodiment is obtained.

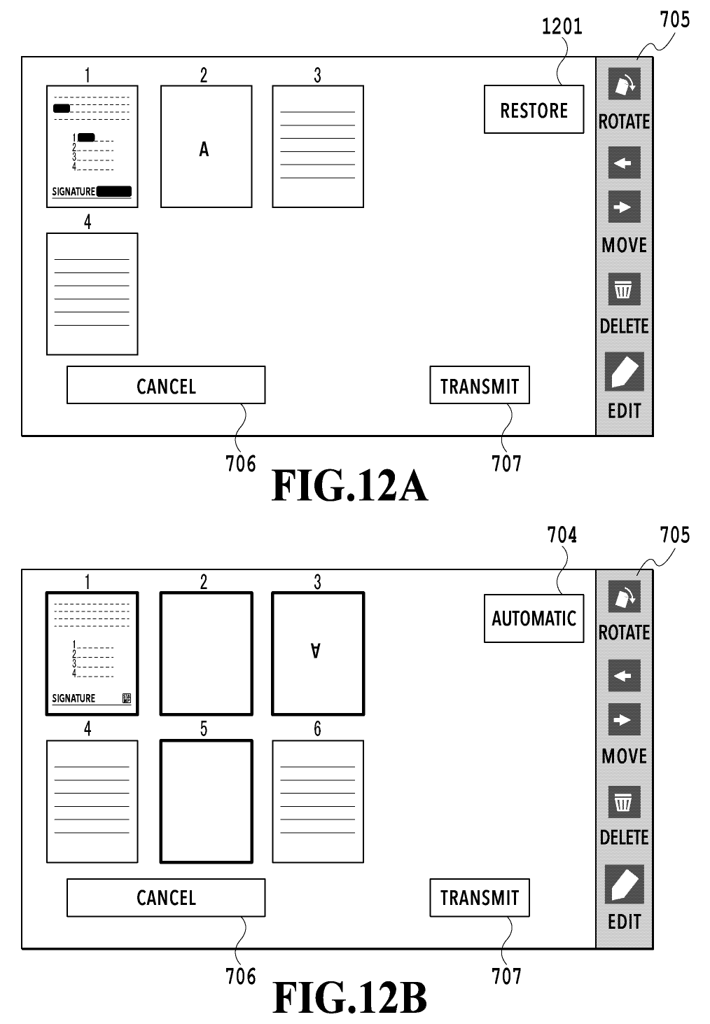

Additionally, the CPU 110 may display an operation object different from the automatic button 704 while changing the display of the preview image to the state reflecting the processing result of the editing. For example, a restoration operation unit that is the operation object to accept an operation to restore to a state before the processing of batch editing of the target page is performed may be displayed. FIG. 12 illustrates an example of another preview screen. Specifically, FIG. 12A is an example of the preview screen after the batch editing, and FIG. 12B is the preview screen in a case of restoring to a state before the batch editing. In FIGS. 12A and 12B, the same elements as that in FIG. 7A are provided with the same reference numerals.

In the example in FIG. 12A, instead of the automatic button 704, a restoration button 1201 is displayed as the restoration operation unit. The restoration button 1201 is displayed by the CPU 110 in a case where the display of the preview image is changed to the state reflecting the processing result of the editing. According to an operation by the user pressing the restoration button 1201, the CPU 110 accepts a display restoration instruction. Once the display restoration instruction is accepted, the CPU 110 restores the display of the preview screen to a state before the processing of batch editing of the target page is performed. Thus, it is possible to cancel the editing processing in a case where the editing result is different from the expectation of the user, and this leads to improvement in the operability.

The CPU 110 may display the restored preview image of the target page so as to be able to distinguish from the preview image of the page other than the target page while restoring the display of the preview screen to a state before the processing of batch editing of the target page is performed. In the example in FIG. 12B, a frame is provided around the restored preview image of the target page. On the other hand, no frame is provided around the preview image of the page other than the target page, and the original state is maintained. The user may figure out the target page at a glance even in a case where many preview images are displayed.

In the above-described embodiment, the source image as the source of the preview image is the page (image) read by the scanner 12; however, it is not limited thereto. For example, the source image may be an image stored in a storage medium such as a memory card. As the source image, a variety of images may be used.

Embodiment(s) of the present disclosure can also be realized by a computer of a system or apparatus that reads out and executes computer executable instructions (e.g., one or more programs) recorded on a storage medium (which may also be referred to more fully as a 'non-transitory computer-readable storage medium') to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

According to the present disclosure, it is possible to achieve good usability.

This application claims the benefit of Japanese Patent Application No. 2025-058807, filed Mar. 31, 2025, which is hereby incorporated by reference herein in its entirety.

What is claimed is:

1. An image processing apparatus comprising:
one or more processors; and
one or more memories storing instructions that, when executed by the one or more processors, cause the image processing apparatus to:
allow a reading unit to read a document;
perform control to display a preview screen including: an operation object to accept execution of processing of batch editing of an editing target; and a preview image based on image data obtained with the reading unit reading the document;
in a case where an operation performed on the operation object is accepted, execute processing of batch editing of a target image, which is a source image including the set editing target in a plurality of source images each corresponding to a source of the preview image; and
in a case where the editing processing is executed, change display of the preview image corresponding to the target image to a state reflecting a result of the editing processing.

2. The image processing apparatus according to claim 1, wherein
the instructions cause the image processing apparatus to further execute the following operations to
set at least one of a plurality of items of different editing contents, and
execute processing of batch editing of the target image corresponding to the set editing contents.

3. The image processing apparatus according to claim 2, wherein
one of the plurality of items is a black-coloring item to perform black-coloring on a designated document portion as the editing target, and
the instructions cause the image processing apparatus to further execute the following operations to
in a case where a setting determination operation performed on the black-coloring item is accepted, set a format of the document read by the reading apparatus and information indicating a designated position in the document, and
perform black-coloring of the designated position in the target image based on the information.

4. The image processing apparatus according to claim 2, wherein
one of the plurality of items is a black-coloring item to perform black-coloring on personal information as the editing target, and
the instructions cause the image processing apparatus to further execute the following operations to
in a case where a setting determination operation performed on the black-coloring item is accepted, set information indicating an automatic detection result of the personal information from the plurality of source images by using a learned machine learning model, and
perform black-coloring of the personal information in the target image based on the information.

5. The image processing apparatus according to claim 2, wherein
the plurality of items include a black-coloring item to perform black-coloring of the editing target, and
the instructions cause the image processing apparatus to further execute the following operation to
perform control to display a source image reflecting the black-coloring resulting from the editing processing.

6. The image processing apparatus according to claim 5, wherein
the instructions cause the image processing apparatus to further execute the following operation to
in a case where there are a plurality of source images including the black-coloring that is a result of the editing processing, perform control to individually display the source images including the black-coloring.

7. The image processing apparatus according to claim 2, wherein
the plurality of items include a blank deletion item to delete a blank image as the editing target and a reverse rotation item to rotate a reverse image as the editing target.

8. The image processing apparatus according to claim 1, wherein
the instructions cause the image processing apparatus to further execute the following operation to
in a case where the editing processing is executed, change display of the operation object to an operation disabled state.

9. The image processing apparatus according to claim 1, wherein
the instructions cause the image processing apparatus to further execute the following operation to
in a case where the editing processing is executed, hide the operation object on the preview screen.

10. The image processing apparatus according to claim 1, wherein
the instructions cause the image processing apparatus to further execute the following operation to
display an operation object to accept execution of processing to restore to a state before the editing processing is performed on the preview screen.

11. The image processing apparatus according to claim 1, wherein
the instructions cause the image processing apparatus to further execute the following operation to
in a case where there is no target image, notify that there is no target image.

12. The image processing apparatus according to claim 1, wherein
the instructions cause the image processing apparatus to further execute the following operation to
in a case where a user allows the result of the editing processing, change display of the preview image according to the allowed processing result, in the preview images corresponding to the target images, to a state reflecting the result of the editing processing.

13. The image processing apparatus according to claim 1, wherein
the instructions cause the image processing apparatus to further execute the following operation to
perform control to individually display the target image on which the editing processing is executed.

14. A control method of an image processing apparatus including a reading unit configured to read a document, comprising:
performing control to display a preview screen including an operation object to accept execution of processing of batch editing of an editing target and a preview images based on image data obtained with the reading unit reading the document;
in a case where an operation performed on the operation object is accepted, executing processing of batch editing of a target image, which is a source image including the set editing target in a plurality of source images each corresponding to a source of the preview image; and
changing display of the preview image corresponding to the target image to a state reflecting a processing result of the executing.

15. A non-transitory computer readable storage medium storing a program for causing a computer to perform a control method of an image processing apparatus, the control method comprising the steps of:
performing control to display a preview screen including an operation object to accept execution of processing of batch editing of an editing target and a preview image based on image data obtained with the reading unit reading the document;
in a case where an operation performed on the operation object is accepted, executing processing of batch editing of a target image, which is a source image including the set editing target in a plurality of source images each corresponding to a source of the preview image; and
changing display of the preview image corresponding to the target image to a state reflecting a processing result of the executing.
